(19) United States
(12) Patent Application Publication
(10) Pub. No.: US 2024/0170202 A1
(43) Pub. Date: May 23, 2024

(54) COIL COMPONENT

(71) Applicant: TDK Corporation, Tokyo (JP)

(72) Inventors: Yuuichi KAWAGUCHI, Tokyo (JP); Naoaki FUJII, Tokyo (JP); Masanori SUZUKI, Tokyo (JP); Takuya TAKEUCHI, Tokyo (JP); Tomonaga NISHIKAWA, Tokyo (JP); Hiroki SHIBA, Tokyo (JP)

(21) Appl. No.: 18/549,264

(22) PCT Filed: Feb. 22, 2022
(86) PCT No.: PCT/JP2022/007195

§ 371 Date: Sep. 6, 2023

(30) Foreign Application Priority Data
Mar. 19, 2021 (JP) 2021-046031

(51) Int. Cl. H01F 27/29; H01F 17/04

(52) U.S. Cl. CPC H01F 27/292; H01F 17/04

(57) ABSTRACT

To improve a coil component having a structure in which a coil part is embedded in a magnetic member. A coil component includes a coil part embedded in the magnetic members and terminal electrodes each made of a conductive paste. Conductor layers constituting the coil part respectively have coil conductor patterns and electrode patterns exposed from a mounting surface. The terminal electrode has an area provided at a position covering the electrode patterns on the mounting surface and areas provided at positions not covering the electrode patterns on the mounting surface. A part of the area constitutes a protruding part protruding in the x-direction. The terminal electrode thus has the protruding part, thereby making misalignment of mounting position in the z-direction less likely to occur at the time of mounting.

### TECHNICAL FIELD

The present invention relates to a coil component and, more particularly, to a coil component having a structure in which a coil part including a plurality of alternately stacked conductor and interlayer insulating layers is embedded in a magnetic member.

### BACKGROUND ART

Patent Document 1 discloses a coil component having a structure in which a coil part including a plurality of alternately stacked conductor and interlayer insulating layers is embedded in a magnetic member. In this coil component, an electrode pattern exposed from a magnetic member is covered with a terminal electrode.

### CITATION LIST

### Patent Document

[Patent Document 1] JP 2019-140202A

### DISCLOSURE OF THE INVENTION

### Problem to be Solved by the Invention

However, a terminal electrode is generally formed by electrolyte plating, so that the planar shape of the terminal electrode is determined depending on the planar shape of an electrode pattern exposed from a magnetic member, which hampers the terminal electrode from being formed into a desired planar shape.

It is therefore an object of the present invention to form a terminal electrode into a desired planar shape in a coli component having a structure in which a coil part including a plurality of alternately stacked conductor and interlayer insulating layers is embedded in a magnetic member.

### Means for Solving the Problem

A coil component according to the present invention includes a magnetic member, a coil part embedded in the magnetic member and including a plurality of conductor and interlayer insulating layers which are alternately stacked in a first direction, and a terminal electrode made of a conductive paste. The plurality of conductor layers each have a coil conductor pattern embedded in the magnetic member and an electrode pattern exposed to a mounting surface parallel to the first direction. The terminal electrode has a first area provided at a position covering the electrode patterns on the mounting surface and second and third areas provided at positions not covering the electrode patterns on the mounting surface. The first area is sandwiched by the second and third areas in the first direction and is larger in width in a second direction perpendicular to the first direction than the second and third areas, whereby a part of the first area constitutes a first protruding part protruding in the second direction.

According to the present invention, a conductive paste is used as the material of the terminal electrode, making it possible to form a terminal electrode into a desired planar shape. In addition, in the present invention, the terminal electrode has the first protruding part in a plan view, thereby making misalignment of mounting position in the first direction less likely to occur at the time of mounting.

In the present invention, the first protruding part may protrude toward the side surface of the magnetic member perpendicular to the second direction. This can suppress the spread of solder fillet formed on the side surface of the magnetic member at the time of mounting. In this case, the first protruding part may decrease in thickness toward the side surface. This can further suppress the spread of solder fillet.

In the present invention, another part of the first area may constitute a second protruding part protruding in the opposite direction in which the first protruding part protrudes. This makes misalignment of mounting position in the first direction still less likely to occur at the time of mounting.

In the present invention, the center portion of the first area may be locally smaller in thickness than the second and third areas, and thus the terminal electrode may have a partial recess. Thus, excessive solder is received in the recess, allowing the spread of solder filler to be further suppressed.

### Advantageous Effects of the Invention

As described above, according to the present invention, it is possible to form a terminal electrode into a desired planar shape in a coli component having a structure in which a coil part including a plurality of alternately stacked conductor and interlayer insulating layers is embedded in a magnetic member.

### BRIEF DESCRIPTION OF THE DRAWINGS

FIG. 1 is a perspective view illustrating the outer appearance of a coil component 10A according to a first embodiment of the present invention.

FIG. 2 is a cross-sectional view of the coil component 10A.

FIG. 3 is a yz side view of the coil component 10A.

FIG. 4 is a yz side view of the coil component 10A.

FIG. 5 is an xy plan view of the coil component 10A.

FIG. 6 is a schematic view for explaining the planar shape of the terminal electrode 71 on the mounting surface S1.

FIG. 7 is a perspective view illustrating a precursor 10 of the coil components 10A and 10B.

FIG. 8 is a top view for explaining ranges W1 and W2 where the conductive paste is applied.

FIG. 9 is a schematic top view showing a state immediately after applying the conductive paste.

FIG. 10 is a perspective view illustrating the outer appearance of a coil component 10B according to a second embodiment of the present invention.

FIG. 11 is a schematic view for explaining the planar shape of the terminal electrode 71 on the mounting surface S1 in the coil component 10B.

FIG. 12 is an xy plan view of the coil component 10B.

FIG. 13 is a schematic top view showing a state immediately after applying the conductive paste.

### MODE FOR CARRYING OUT THE INVENTION

Hereinafter, preferred embodiments of the present invention will be described in detail with reference to the accompanying drawings.

### First Embodiment

FIG. 1 is a perspective view illustrating the outer appearance of a coil component 10A according to a first embodiment of the present invention.

The coil component 10A according to the first embodiment of the present invention is a surface-mount type chip component and includes, as illustrated in FIG. 1, magnetic members 11, 12 and a coil part 20 embedded in the magnetic members 11 and 12. Although the specific details will be described later, the coil part 20 according to the present embodiment has a configuration in which four conductor layers each having a coil conductor pattern are stacked to form one series-connected coil whose one end is connected to a terminal electrode 71 and whose the other end is connected to a terminal electrode 72. The terminal electrodes 71 and 72 are each made of a conductive paste such as a nano silver paste or a nano-copper paste, and the surfaces thereof are covered with a laminated film of nickel (Ni) and tin (Sn) so as to ensure wettability to a solder.

The magnetic members 11 and 12 are each a composite member made of resin containing magnetic powder such as ferrite powder or magnetic metal powder and form a magnetic path for magnetic flux generated by a current flowing in the coil part 20. When magnetic metal powder is used as the magnetic powder, a permalloy-based material is preferably used. The resin is preferably epoxy resin in the form of liquid or powder. However, in the present invention, the magnetic members 11 and 12 need not necessarily be made of a composite member, but, for example, a substrate made of a magnetic material such as a sintered ferrite may be used as the magnetic member 11.

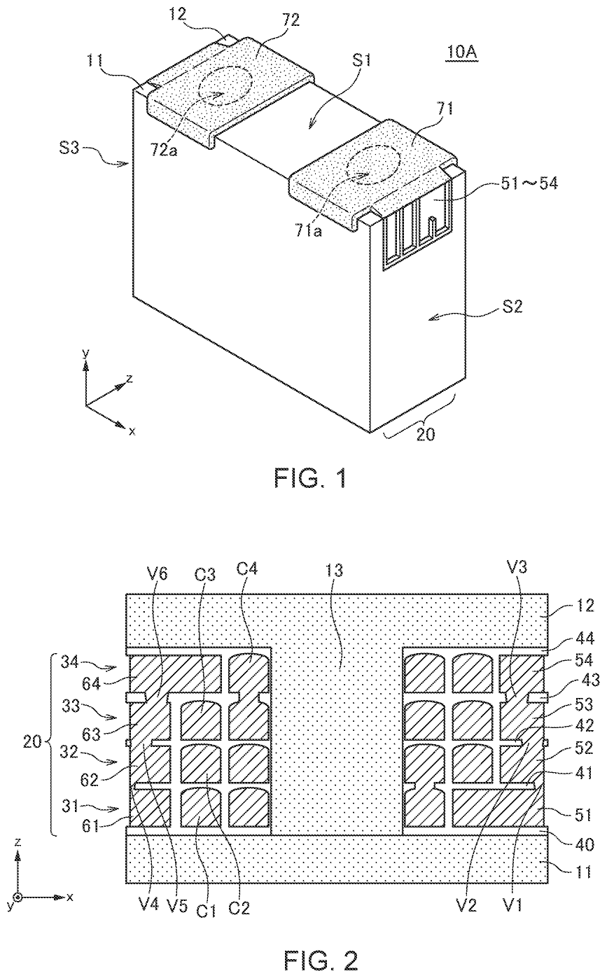

FIG. 2 is a cross-sectional view of the coil component 10A according to the present embodiment.

As illustrated in FIG. 2, the coil part 20 included in the coil component 10A is configured such that it is sandwiched by the two magnetic members 11 and 12 and that interlayer insulating layers 40 to 44 and conductor layers 31 to 34 are alternately stacked in the z-direction. The conductor layers 31 to 34 are connected to one another through through-holes formed in the interlayer insulating layers 41 to 43 to constitute one series-connected coil. The inner diameter part of the coil is filled with a magnetic member 13 made of the same material as the magnetic member 12. The interlayer insulating layers 40 to 44 are made of resin, for example, and a non-magnetic material is used for at least the interlayer insulating layers 41 to 43. A magnetic material may be used for the interlayer insulating layer 40 positioned in the lowermost layer and the interlayer insulating layer 44 positioned in the uppermost layer.

The conductor layer 31 is the first conductor layer formed on the upper surface of the magnetic member 11 through the interlayer insulating layer 40. The conductor layer 31 has a coil conductor pattern C1 spirally wound in two turns and two electrode patterns 51 and 61. The electrode pattern 51 is connected to one end of the coil conductor pattern C1, while the electrode pattern 61 is provided independently of the coil conductor pattern C1. The coil conductor pattern C1 is embedded in the coil part 20, and the electrode patterns 51 and 61 are each partly exposed from the coil part 20.

The conductor layer 32 is the second conductor layer formed on the upper surface of the conductor layer 31 through the interlayer insulating layer 41. The conductor layer 32 has a coil conductor pattern C2 spirally wound in two turns and two electrode patterns 52 and 62. The electrode patterns 52 and 62 are both provided independently of the coil conductor pattern C2. The coil conductor pattern C2 is embedded in the coil part 20, and the electrode patterns 52 and 62 are each partly exposed from the coil part 20.

The conductor layer 33 is the third conductor layer formed on the upper surface of the conductor layer 32 through the interlayer insulating layer 42. The conductor layer 33 has a coil conductor pattern C3 spirally wound in two turns and two electrode patterns 53 and 63. The electrode patterns 53 and 63 are both provided independently of the coil conductor pattern C3. The coil conductor pattern C3 is embedded in the coil part 20, and the electrode patterns 53 and 63 are each partly exposed from the coil part 20.

The conductor layer 34 is the fourth conductor layer formed on the upper surface of the conductor layer 33 through the interlayer insulating layer 43. The conductor layer 34 has a coil conductor pattern C4 spirally wound in two turns and two electrode patterns 54 and 64. The electrode pattern 64 is connected to one end of the coil conductor pattern C4, while the electrode pattern 54 is provided independently of the coil conductor pattern C4. The coil conductor pattern C4 is embedded in the coil part 20, and the electrode patterns 54 and 64 are each partly exposed from the coil part 20.

The coil conductor patterns C1 and C2 are connected to each other through a via conductor penetrating the interlayer insulating layer 41, the coil conductor patterns C2 and C3 are connected to each other through a via conductor penetrating the interlayer insulating layer 42, and the coil conductor patterns C3 and C4 are connected to each other through a via conductor penetrating the interlayer insulating layer 43. As a result, the coil conductor patterns C1 to C4 constitute an eight-turn coil, one end of which is connected to the terminal electrode 71 and the other end thereof is connected to the terminal electrode 72.

The electrode patterns 51 to 54 are connected to one another through via conductors V1 to V3 penetrating respectively the interlayer insulating layers 41 to 43. Similarly, the electrode patterns 61 to 64 are connected to one another through via conductors V4 to V6 penetrating respectively the interlayer insulating layers 41 to 43. The formation positions of the via conductors V1 to V3 as viewed in the stacking direction differ from one another, and formation positions of the via conductors V4 to V6 as viewed in the stacking direction also differ from one another.

Unlike general multilayer coil components, the coil component 10A according to the present embodiment is vertically mounted such that the z-direction (stacking direction) is parallel to a circuit board. Specifically, the surface constituting the xz plane is used as a mounting surface S1, on which the terminal electrodes 71 and 72 are provided.

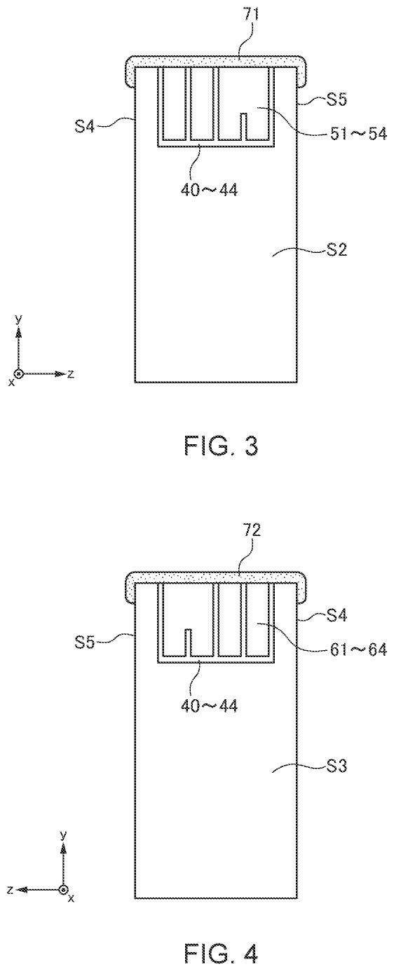

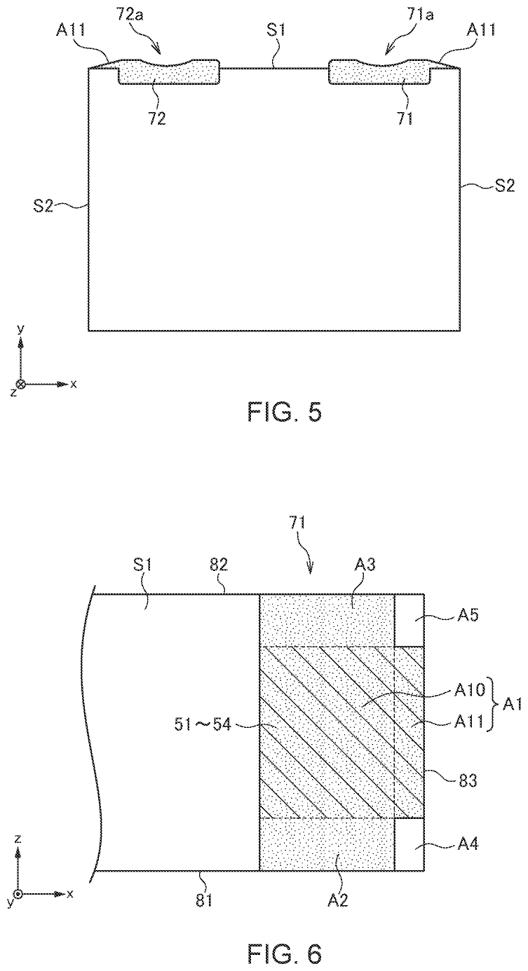

FIGS. 3 and 4 are a yz side view of the coil component 10A, and FIG. 5 is an xy plan view of the coil component 10A.

As illustrated in FIG. 3, a part of each of the electrode patterns 51 to 54 and a part of each of the interlayer insulating layers 40 to 44 are exposed to a side surface S2 constituting one yz plane. Similarly, as illustrated in FIG. 4, a part of each of the electrode patterns 61 to 64 and a part of each of the interlayer insulating layers 40 to 44 are exposed to a side surface S3 constituting the other yz plane. As illustrated in FIG. 5, the electrode patterns 51 to 54 and 61 to 64 are not exposed to a side surface S4 constituting one xy surface. Similarly, although not illustrated, the electrode patterns 51 to 54 and 61 to 64 are not exposed to a side surface S5 constituting the other xy surface. A part of each of the terminal electrodes 71 and 72 are formed on the side surfaces S4 and S5. The terminal electrode 71 contacts the electrode patterns 51 to 54 exposed to the mounting surface S1, and the terminal electrode 72 contacts the electrode patterns 61 to 64 exposed to the mounting surface S1.

FIG. 6 is a schematic view for explaining the planar shape of the terminal electrode 71 on the mounting surface S1. Although not illustrated, the planar shape of the terminal electrode 72 on the mounting surface S1 is the same.

The hatched area in FIG. 6 is an area where the electrode patterns 51 to 54 are exposed. The terminal electrode 71 has a first area A1 provided at a position covering the electrode patterns 51 to 54 on the mounting surface S1 and second and third areas A2 and A3 provided at positions not covering the electrode patterns 51 to 54 on the mounting surface S1. The area A1 is sandwiched by the areas A2 and A3 in the z-direction.

The position and planar shape of the area A1 substantially coincide with the position and planar shape of the exposed area of the electrode patterns 51 to 54. Accordingly, the widths of the area A1 in the x- and z-directions substantially coincide with the widths of the exposed area of the electrode patterns 51 to 54 in the x- and z-directions. On the other hand, the width of each of the areas A2 and A3 in the x-direction is smaller than the width of the area A1 in the x-direction, whereby a part of the area A1 constitutes a protruding part A11 protruding in the x-direction. That is, when a part of the area A1 that coincides in position with the areas A2 and A3 is defined as a main part A10, the area A1 is constituted by the main part A10 and protruding part A11.

Since the terminal electrode 71 has the protruding part A11 protruding in the x-direction as described above, areas A4 and A5 where the terminal electrode 71 does not exist are formed on the mounting surface S1. The width of each of the areas A4 and A5 in the x-direction substantially coincides with the width of the protruding part A11 in the x-direction, and the width of each of the areas A4 and A5 in the z-direction also substantially coincides with the width of each of the areas A2 and A3 in the z-direction. When defining an edge 81 which is the boundary between the mounting surface S1 and the side surface S4 and which extends in the x-direction, an edge 82 which is the boundary between the mounting surface S1 and the side surface S5 and which extends in the x-direction, and an edge 83 which is the boundary between the mounting surface S1 and the side surface S2 and which extends in the z-direction are defined, the area A4 is surrounded by the edges 81 and 83, the area A2, and the protruding part A11, and the area A5 is surrounded by the edges 82 and 83, the area A3, and the protruding part A11.

As described above, the terminal electrodes 71 and 72 each have the above-described planar shape on the mounting surface S1, and the areas A4 and A5 where the terminal electrode 71 does not exist are provided on both sides of the protruding part A11 in the z-direction, thereby making misalignment of mounting position in the z-direction less likely to occur at the time of mounting. That is, the areas A4 and A5 are insulating areas and have no wettability to a solder, so that the protruding part A11 is positioned at the center of a land pattern in the z-direction, and misalignment thereof in the z-direction is prevented by the areas A4 and A5.

In addition, in the present embodiment, as illustrated in FIG. 5, the thickness of the protruding part A11 in the y-direction decreases toward the side surface S2. This suppresses the spread of solder fillet formed on the side surface S2, allowing achievement of high-density mounting. Further, in the present embodiment, the center portion of the area A1 is locally smaller in thickness than the areas A2 and A3, whereby the terminal electrodes 71 and 72 have partial recesses 71a and 72a, respectively. Thus, excessive solder is received in the recesses 71a and 72a at the time of mounting, allowing the spread of solder filler to be further suppressed.

The following describes a method of forming the terminal electrodes 71 and 72 having the above shape.

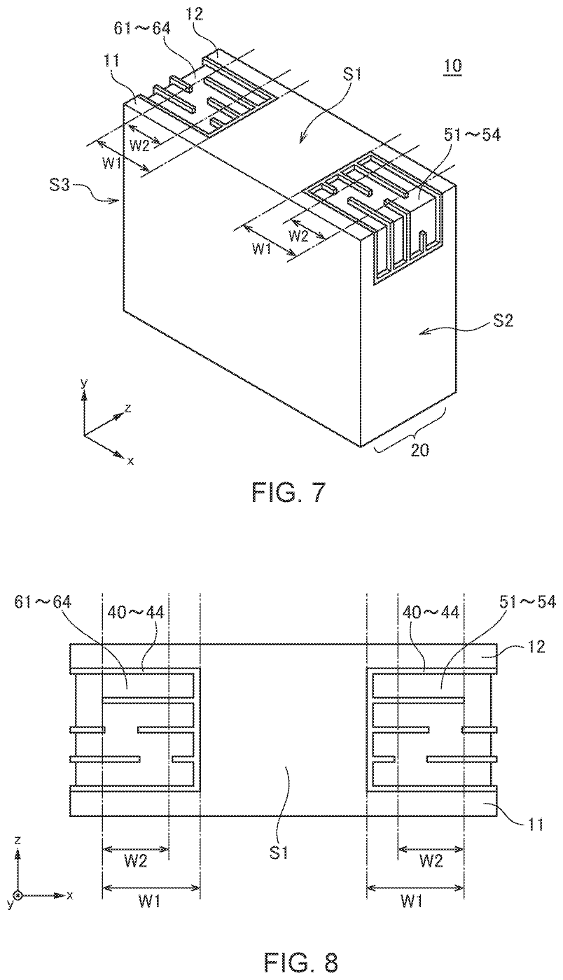

The interlayer insulating layers 40 to 44 and the conductor layers 31 to 34 are alternately stacked in the z-direction to form the coil part 20, and the coil part 20 is embedded in the magnetic members 11 to 13, whereby a precursor 10 of the coil component 10A is obtained as illustrated in FIG. 7. Subsequently, a conductive paste is applied onto a range W1 illustrated in FIGS. 7 and 8. Application of the conductive paste can be achieved by rotating a roller charged with the conductive paste along a groove having a width corresponding to the range W1 and thus transferring the conductive paste onto the mounting surface S1.

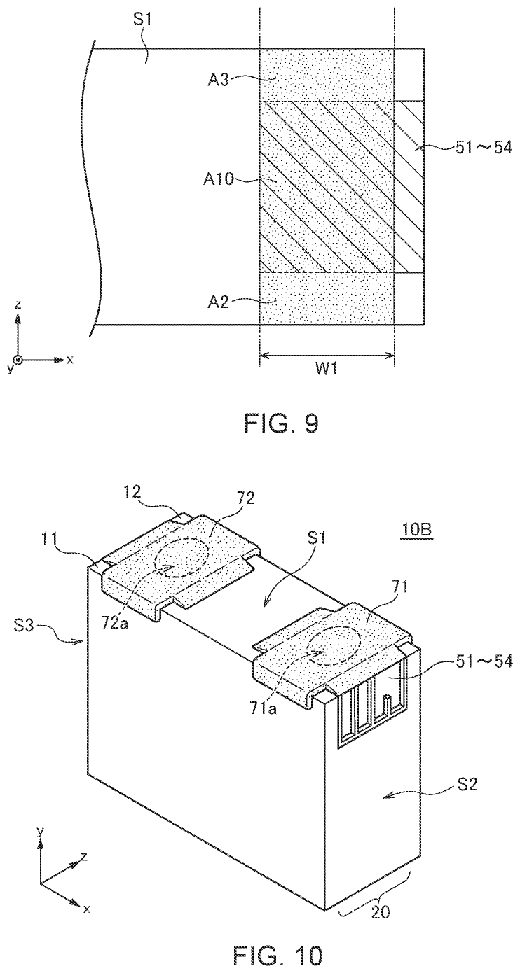

The range W1 is a range excluding a portion in the vicinity of the side surface S2 (S3) out of the electrode patterns 51 to 54 (61 to 64) exposed to the mounting surface S1. Thus, in the initial stage of forming the terminal electrodes, the main part A10 and the areas A2 and A3 of the terminal electrode 71 (72) are formed on the mounting surface S1, as illustrated in FIG. 9 which is a schematic plan view. At this point of time, a part of each of the electrode patterns 51 to 54 (61 to 64) in the vicinity of the side surface S2 (S3) is exposed; however, by adjusting conditions of the conductive paste such as composition, viscosity, and temperature, the conductive paste is allowed to flow to the exposed area of the electrode patterns 51 to 54 (61 to 64), whereby the protruding part A11 illustrated in FIG. 6 is formed.

When the protruding part A11 is thus formed by the flowing of the conductive paste, it is possible to obtain a shape reducing in thickness toward the side surface S2 (S3), as described using FIG. 5. Further, the conductive paste applied onto the main part A10 decreases in volume as it flows, and thus the recess 71a (72a) is formed in the main part A10.

### Second Embodiment

FIG. 10 is a perspective view illustrating the outer appearance of a coil component 10B according to a second embodiment of the present invention.

The coil component 10B according to the second embodiment differs from the coil component 10A according to the first embodiment in the planar shape of the terminal electrodes 71 and 72 on the mounting surface S1. Other basic configurations are the same as those of the coil component 10A according to the first embodiment, so the same reference numerals are given to the same elements, and overlapping description will be omitted.

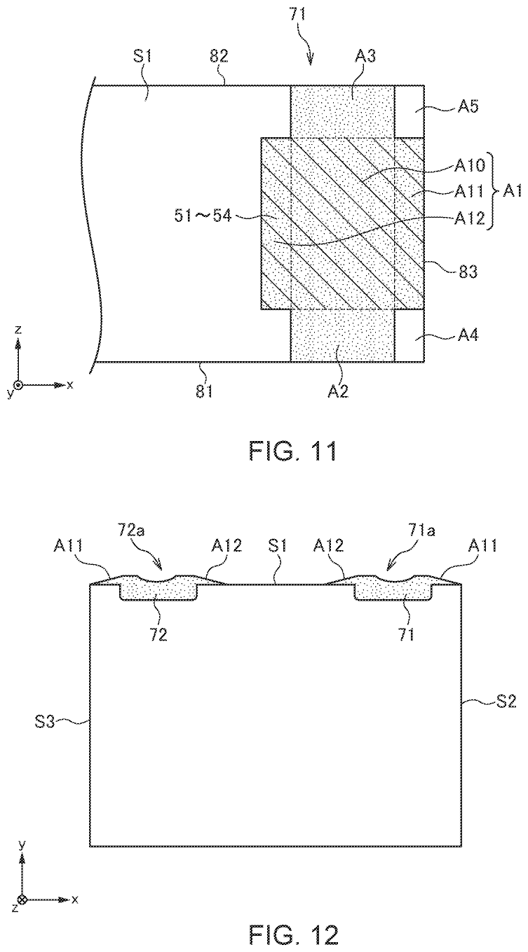

FIG. 11 is a schematic view for explaining the planar shape of the terminal electrode 71 on the mounting surface S1 in the coil component 10B according to the second embodiment. Although not illustrated, the planar shape of the terminal electrode 72 on the mounting surface S1 is the same.

The hatched area in FIG. 11 is an area where the electrode patterns 51 to 54 are exposed. The terminal electrode 71 has a first area A1 provided at a position covering the electrode patterns 51 to 54 on the mounting surface S1 and second and third areas A2 and A3 provided at positions not covering the electrode patterns 51 to 54 on the mounting surface S1. The area A1 is sandwiched by the areas A2 and A3 in the z-direction.

The position and planar shape of the area A1 substantially coincide with the position and planar shape of the exposed area of the electrode patterns 51 to 54. Accordingly, the widths of the area A1 in the x- and z-directions substantially coincide with the widths of the exposed area of the electrode patterns 51 to 54 in the x- and z-directions. On the other hand, the width of each of the areas A2 and A3 in the x-direction is smaller than the width of the area A1 in the x-direction, whereby the area A1 has protruding parts A11 and A12 protruding in the x-direction. The protruding parts A11 and A12 protrude in the opposite directions, and the main part A10 is sandwiched by the protruding parts A11 and A12 in the x-direction.

As described above, the terminal electrodes 71 and 72 each further have the protruding part A12 protruding in the x-direction, so that the edges of the protruding parts A11 and A12 in the z-direction function as a stopper that prevents misalignment of the coil component 10B in the z-direction at the time of mounting.

In addition, as illustrated in FIG. 12 which is an xy plan view of the coil component 10B, the thickness of each of the protruding parts A11 and A12 in the y-direction decreases with increasing distance from the main part A10. This facilitates the supply of underfill between the terminal electrodes 71 and 72 at the time of mounting.

The following describes a method of forming the terminal electrodes 71 and 72 having the above shape.

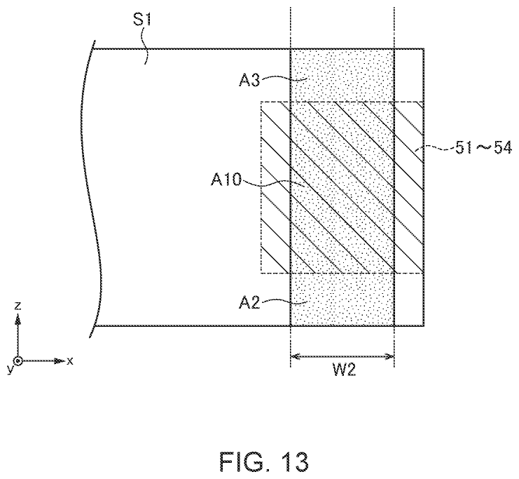

After a precursor 10 of the coil component 10B is obtained as illustrated in FIG. 7, a conductive paste is applied onto a range W2 illustrated in FIGS. 7 and 8. The range W2 is a range excluding both end portions in the x-direction out of the electrode patterns 51 to 54 (61 to 64) exposed to the mounting surface S1. Thus, in the initial stage of forming the terminal electrodes, the main part A10 and areas A2 and A3 of the terminal electrode 71 (72) are formed on the mounting surface S1, as illustrated in FIG. 13 which is a schematic plan view. At this point of time, the both end portions of each of the electrode patterns 51 to 54 (61 to 64) in the x-direction are exposed; however, by adjusting conditions of the conductive paste such as composition, viscosity, and temperature, the conductive paste is allowed to flow to the exposed area of the electrode patterns 51 to 54 (61 to 64), whereby the protruding parts A11 and A12 illustrated in FIG. 11 are formed.

When the protruding parts A11 and A12 are thus formed by the flowing of the conductive paste, it is possible to obtain a shape decreasing in thickness with increasing distance from the main part A10, as described using FIG. 12. Further, the conductive paste applied onto the main part A10 decreases in volume as it flows, and thus the recess 71a (72a) is formed in the main part A10.

While the preferred embodiment of the present disclosure has been described, the present disclosure is not limited to the above embodiment, and various modifications may be made within the scope of the present disclosure, and all such modifications are included in the present disclosure.

For example, although the coil part 20 includes the four conductor layers 31 to 34 in the above embodiments, the number of the conductor layers is not limited to four in the present invention. Further, the number of turns of the coil conductor pattern formed in each conductor layer is also not particularly limited to a specific number.

### REFERENCE SIGNS LIST

10 precursor
10A, 10B coil component
11-13 magnetic members
20 coil part
31-34 conductor layer
40-44 interlayer insulating layer
51-54, 61-64 electrode pattern
71, 72 terminal electrode
71a, 72a recess
81-83 edge
A1 first area
A10 main part
A11, A12 protruding part
A2 second area
A3 third area
A4 fourth area
A5 fifth area
C1-C4 coil conductor pattern
S1 mounting surface
S2-S5 side surface
V1-V6 via conductor
W1, W2 application range of conductive paste

1. A coil component comprising:
a magnetic member;
a coil part embedded in the magnetic member and including a plurality of conductor and interlayer insulating layers which are alternately stacked in a first direction; and
a terminal electrode made of a conductive paste,
wherein each of the plurality of conductor layers has a coil conductor pattern embedded in the magnetic member and an electrode pattern exposed to a mounting surface parallel to the first direction,
wherein the terminal electrode has a first area provided at a position covering the electrode patterns on the mounting surface and second and third areas provided at positions not covering the electrode patterns on the mounting surface,
wherein the first area is sandwiched by the second and third areas in the first direction, and
wherein the first area is larger in width in a second direction perpendicular to the first direction than the second and third areas, whereby a part of the first area constitutes a first protruding part protruding in the second direction.

2. The coil component as claimed in claim 1, wherein the first protruding part protrudes toward a side surface of the magnetic member perpendicular to the second direction.

3. The coil component as claimed in claim 2, wherein the first protruding part decreases in thickness toward the side surface.

4. The coil component as claimed in claim 1, wherein another part of the first area constitutes a second protruding part protruding in an opposite direction in which the first protruding part protrudes.

5. The coil component as claimed in claim 1, wherein a center portion of the first area is locally smaller in thickness than the second and third areas, whereby the terminal electrode has a partial recess.
